(19) United States
(12) Patent Application Publication
(10) Pub. No.: US 2010/0307690 A1
(43) Pub. Date: Dec. 9, 2010

(54) LAMINATING MACHINE

(76) Inventor: Kuang-Hui CHOU, Taipei Hsien (TW)

Correspondence Address: BIRCH STEWART KOLASCH & BIRCH, PO BOX 747, FALLS CHURCH, VA, 22040-0747, US

(21) Appl. No.: 12/478,196

(22) Filed: Jun. 4, 2009

(51) Int. Cl. B32B 37/10

(52) U.S. Cl. 156/555

(57) ABSTRACT

A laminating machine is provided therein with an upper guide plate and a lower guide plate that disposed opposite each other. A workpiece to be laminated passes through a guide slot formed between the upper and lower guide plates, wherein the upper guide plate can be pushed upward, and a micro switch is provided above the upper guide plate for controlling the rotation of roller sets. If the workpiece is too thick or is somehow impeded such that the workpiece creases, the upper guide plate will be pushed upward by the workpiece and therefore touches the micro switch. As a result, another circuit is activated to rotate the roller sets reversely and thereby eject the workpiece. Hence, not only is the laminating machine protected and saved from a lot of maintenance work, but also precious paper documents, such as photos, in the workpiece are well preserved.

### BACKGROUND OF THE INVENTION

1. Technical Field

The present invention relates to laminating machines and, more particularly, to a laminating machine having a safety device such that, when a workpiece fed into the laminating machine is impeded, a mechanism for rotating rollers of the laminating machine in a reverse direction is activated to eject the workpiece.

2. Description of Related Art

Lamination is the easiest and most common solution to preserving important paper documents, such as photos, which tend to yellow with age or are easily damaged. Basically, lamination is carried out in the following manner. A paper document is placed between two slightly larger films which are sealed together at one end and left open at the opposite end. Then, the films with the paper document sandwiched therebetween are fed into the feed port of a laminating machine, with the sealed end of the films as the leading end. After being heated and rolled by the laminating machine, the paper document is hot-pressed between, and thus forms an integral unit with, the two films. Consequently, the paper document which is worth preserving and now sealed between the films is blocked from oxidation and water stain. In addition, the jacket formed by the films has certain structural strength that provides effective protection against unexpected tearing or folding. Therefore, lamination has been widely adopted for preserving all kinds of paper documents.

Generally, a laminating machine is operated as follows. The machine is started and allowed to warm up, during which time roller sets in the machine are heated and driven to rotate. When the temperature reaches a predetermined threshold, a workpiece is pushed into the feed port of the laminating machine for lamination. In order to cope with workpieces of various sizes, the width of the feed port is designed according to the maximum width of potential workpieces. However, such design rule may cause trouble to workpieces whose dimensions are less than the maximum design specifications. More specifically, if a workpiece falling short of the maximum design width is fed into the lamination machine in such a way that the leading end of the workpiece turns to a side upon touching the first roller set, the entire workpiece may pass through between the following roller sets slantingly during the hot press process so that the workpiece ends up creased and gets stuck in the laminating machine, thereby damaging the precious paper document in the workpiece. If the workpiece is jammed in the laminating machine for a long time, the films may overheat, deform, and eventually melt over the paper document sandwiched between the films. This is a major drawback of the conventional laminating machine.

Although it is possible to turn off the laminating machine immediately after the deviation of a workpiece is detected, the workpiece is very likely to remain in the machine and cannot be removed therefrom after the machined is turned off due to the generally small length of the workpiece and the relatively high rolling speed. As a result, the paper document in the workpiece may still be deformed and damaged.

In order to prevent the above scenarios, an improved laminating machine is provided with a safety device such that, when a workpiece pushed into the laminating machine does not show up at the other end of the machine after a predetermined amount of time, it is determined that the workpiece is stuck, and the rollers will stop rotating so as to prevent the machine from damage. Nevertheless, the hot rollers may still impair the workpiece. If the workpiece contains valuable paper documents, the loss will be inestimable and regrettably irremediable.

Hence, the design of the conventional laminating machines requires further improvement for protecting workpieces as well as safeguarding consumers' rights.

### BRIEF SUMMARY OF THE INVENTION

A primary objective of the present invention is to provide oppositely disposed upper and lower guide plates in a laminating machine such that a workpiece to be laminated passes through a guide slot formed between the upper and lower guide plates. Therein, the upper guide plate can be pushed upward, and a micro switch is provided above the upper guide plate for controlling the rotation of roller sets. If the workpiece is too thick or is somehow impeded such that the workpiece form creases, the upper guide plate will be pushed by the workpiece and in consequence touches the micro switch, thus activating another circuit to rotate the roller sets reversely and thereby eject the workpiece. Hence, not only is the laminating machine protected, but also the precious paper document in the workpiece is properly preserved.

The structure and technical means adopted by the present invention to achieve the above and other objectives are as follows:

A laminating machine includes a base mounted with a pair of frames that are arranged opposite each other. Each of the frames is formed with a plurality of axial holes while roller sets are pivotally provided between the corresponding axial holes of the frames. Each of the frames is also formed with insertion notches located between the axial holes. In addition, at least one of the insertion notches is provided thereabove with a micro switch for activating a reverse rotation mechanism of the roller sets.

A gear set is provided on one side of one of the frames and configured to drive the roller sets for forward or reverse rotation.

The laminating machine further includes at least one pair of oppositely disposed upper and lower guide plates. Each pair of the upper and lower guide plates has two ends coupled with the corresponding insertion notches of the two frames, respectively, wherein the paired upper and lower guide plates form a guide slot therebetween. Besides, each of the at least one upper guide plate can be pushed upward such that each of the at least one micro switch is touchable by the corresponding upper guide plate that is pushed upward by a predetermined distance. Thus, when a workpiece gets stuck, the reverse rotation mechanism of the roller sets can be timely activated to eject the workpiece, thereby protecting the laminating machine from wear and preventing the precious original document inside the workpiece from being torn or damaged during the hot press process.

Hence, the laminating machine according to the present invention provides enhanced lamination quality and helps preserve precious paper documents.

### BRIEF DESCRIPTION OF THE SEVERAL VIEWS OF THE DRAWINGS

The invention as well as a preferred mode of use, further objectives, and advantages thereof will be best understood by referring to the following detailed description of an illustrative embodiment in conjunction with the accompanying drawings, wherein:

FIG. 1 is a perspective see-through view of a laminating machine according to the present invention;

FIG. 2 is a sectional view of the laminating machine according to the present invention;

FIG. 3 is a perspective view of major components of the laminating machine according to the present invention;

FIG. 4 is a sectional view showing operation of the laminating machine according to the present invention; and

FIG. 5 is an exploded perspective view of the major components of the laminating machine according to the present invention.

### DETAILED DESCRIPTION OF THE INVENTION

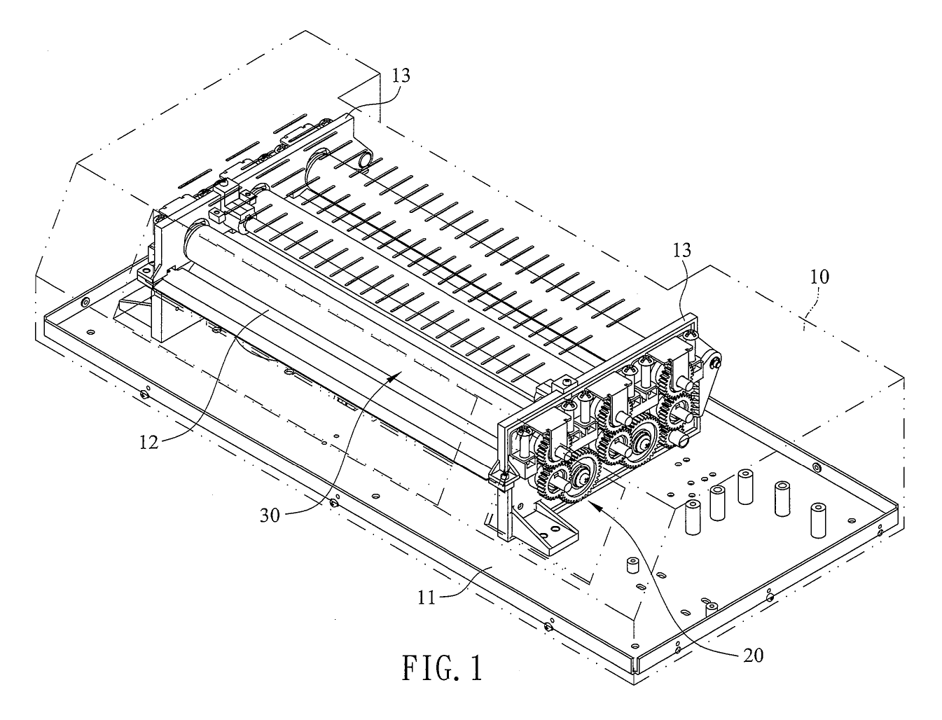

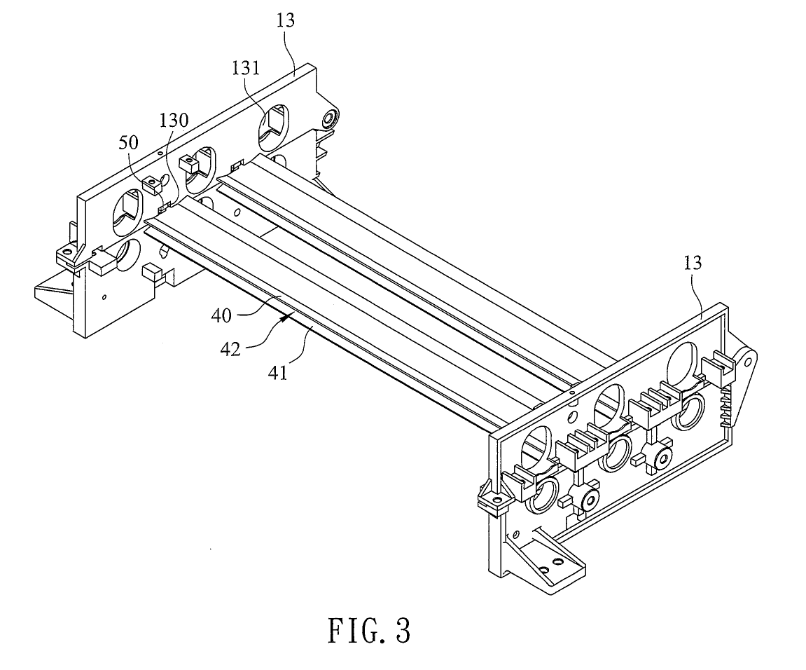

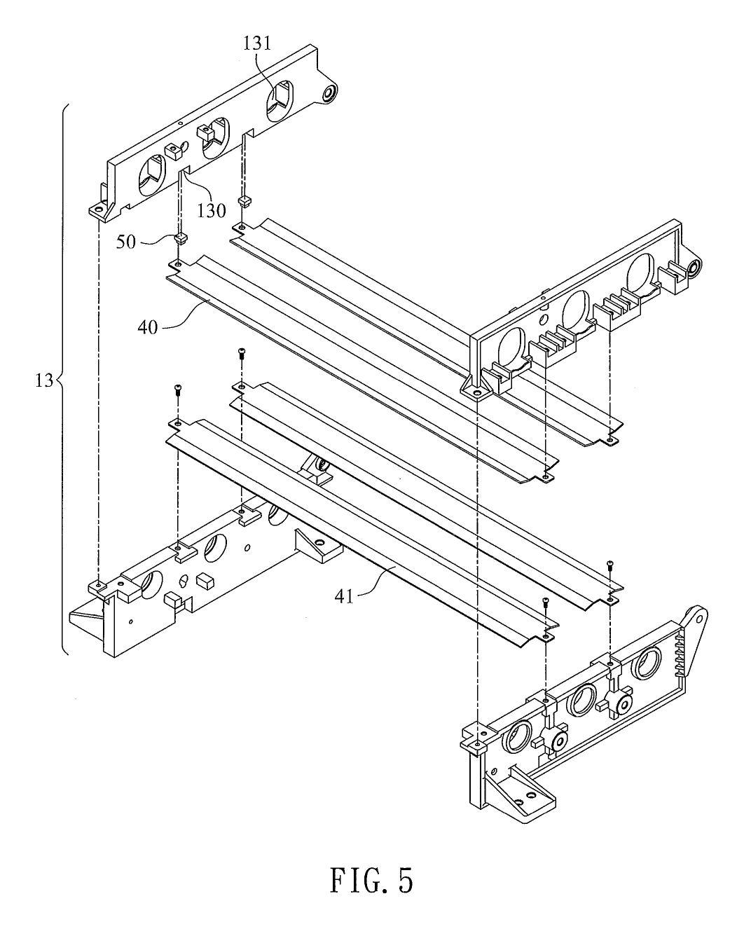

Referring to FIG. 1, a laminating machine according to the present invention includes a machine body 10 having a base 11. A pair of frames 13 are mounted on the base 11 and arranged opposite each other. Referring to FIG. 1 in conjunction with FIG. 3 and FIG. 5, each of the frames 13 is formed with a plurality of axial holes 131 such that roller sets 30 are pivotally provided between the corresponding axial holes 131 of the two frames 13. In addition, each of the frames 13 is formed with insertion notches 130 between the axial holes 131. The insertion notches 130 of one frame 13 correspond in position to the insertion holes 130 of the other frame 13. Furthermore, at least one of the insertion notches 130 is provided thereabove with a micro switch 50 configured for activating a reverse rotation mechanism of the roller sets 30. The circuit design of the micro switch 50 and the reverse rotation mechanism is not a technical feature of the present invention and therefore will not be detailed herein.

A gear set 20 is provided on one side of one of the frames 13 and configured to drive the roller sets 30 for forward or reverse rotation.

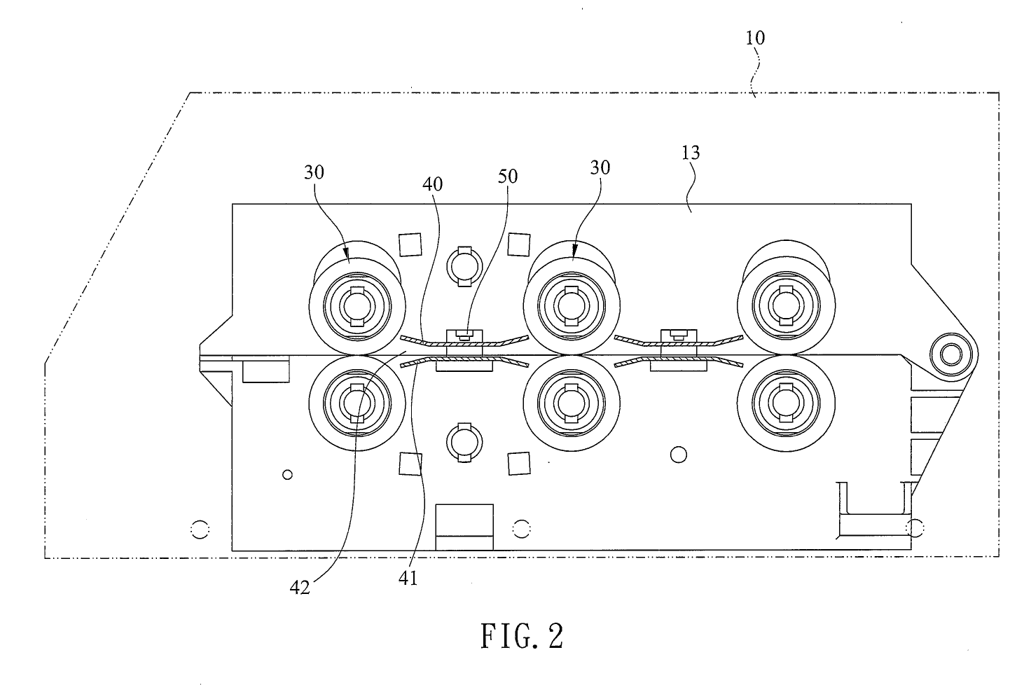

Referring to FIGS. 2, 3, and 4, the laminating machine further includes at least one pair of upper and lower guide plates 40 and 41 that are disposed opposite each other. Each pair of the upper and lower guide plates 40, 41 has two ends coupled with the corresponding insertion notches 130 of the two frames 13, respectively. The upper and lower guide plates 40 and 41 of each pair form a guide slot 42 therebetween for a workpiece 60 to pass through rapidly and safely. Each of the upper guide plates 40 can be pushed upward such that each of the at least one micro switch 50 is touchable by the corresponding upper guide plate 40 that has been pushed upward by a predetermined distance. Furthermore, each of the upper and lower guide plates 40, 41 has a forward edge and a rearward edge that are extended outward to form a flared shape, thereby facilitating entry and exit of the workpiece 60.

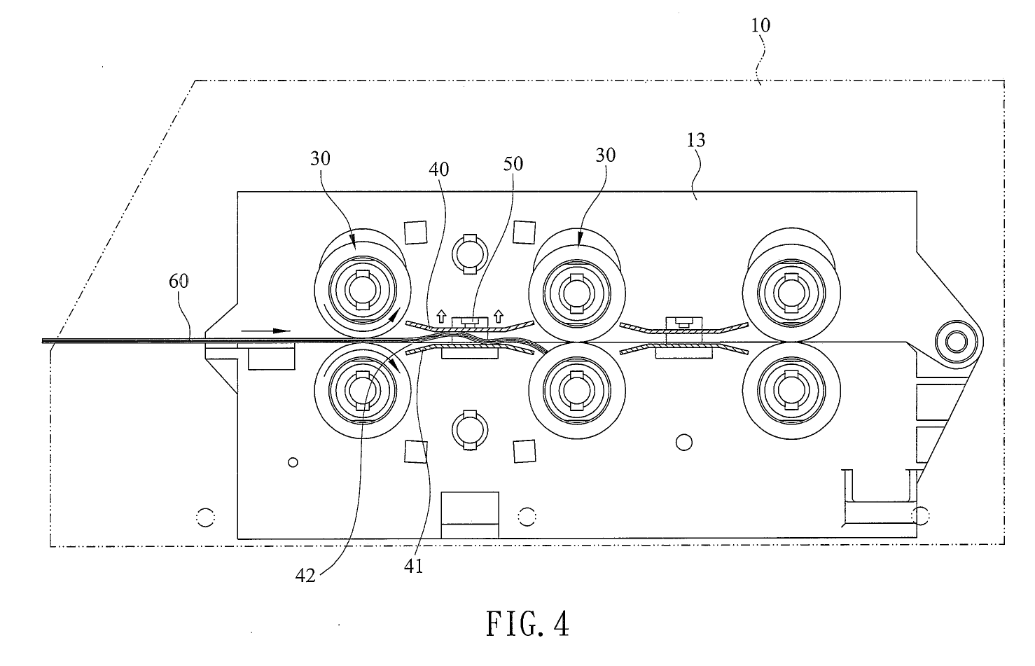

Referring to FIGS. 2 and 4, the workpiece 60 (such as a photo sandwiched between two films) entering a feed port 12 at a front end of the laminating machine is hot-pressed by the first roller set 30 and then passes through the guide slot 42 formed between the first upper guide plate 40 and the first lower guide plate 41. At this time, if the workpiece 60 creases due to an excessively large thickness thereof or due to improper operation, as shown in FIG. 4, the workpiece 60 will push the first upper guide plate 40 upward such that the first upper guide plate 40 touches the first micro switch 50. The first micro switch 50 then activates another circuit to rotate the roller sets 30 in a reverse direction, thereby ejecting the workpiece 60. As a result, the roller sets 30 are prevented from running idle while the important photo in the workpiece 60 is protected from damage, which is a major feature of the present invention.

According to the present invention, when a workpiece fed into the laminating machine creases, either due to an excessively large thickness thereof or due to an improper inserting operation, the workpiece will push the upper guide plate upward such that the upper guide plate touches the micro switch and thus activates another circuit to drive the roller sets for reverse rotation, thereby ejecting the workpiece automatically. Therefore, not only is the laminating machine protected and saved from the trouble of maintenance that may otherwise result from a jammed workpiece, but also the precious paper document is well preserved. Hence, the present invention is useful and has industrial applicability.

The present invention is described herein by reference to the preferred embodiment. However, it is understood that the embodiment is not intended to limit the scope of the present invention. Since equivalent or minor changes to the disclosed embodiment, such as minor changes in the shape and position of the upper and lower guide plates, are easily conceivable by a person skilled in the art, all such equivalent changes or modifications which do not depart from the concept and scope of the present invention should be encompassed by the appended claims.

In conclusion, the laminating machine according to the present invention has not been put to public use, demonstrates industrial applicability, and thus meets the requirements of novelty and utility for patent application. Therefore, an application for patent of the present invention is hereby lawfully filed for examination.

What is claimed is:

1. A laminating machine, comprising:
a pair of oppositely disposed frames, each formed with a plurality of axial holes, wherein roller sets are pivotally provided between corresponding ones of the axial holes of the frames, insertion notches are provided between the axial holes of each said frame such that the insertion notches of one said frame correspond in position to the insertion notches of the other said frame, and at least one said insertion notch is provided thereabove with a micro switch for activating a reverse rotation mechanism of the roller sets;
a gear set provided on a side of one said frame and configured to drive the roller sets for forward or reverse rotation; and
at least a pair of oppositely disposed upper and lower guide plates, each said pair having two ends coupled with corresponding ones of the insertion notches of the two frames, respectively, wherein the upper and lower guide plates of each said pair form a guide slot therebetween, and each said upper guide plate can be pushed upward such that each said micro switch is touchable by a corresponding said upper guide plate that is pushed upward by a predetermined distance.

2. The laminating machine of claim 1, wherein each said upper guide plate has a forward edge and a rearward edge which are extended outward to form a flared shape.

3. The laminating machine of claim 1, wherein each said lower guide plate has a forward edge and a rearward edge which are extended outward to form a flared shape.
